(19) United States
(12) Patent Application Publication
(10) Pub. No.: US 2025/0279661 A1
(43) Pub. Date: Sep. 4, 2025

(54) ISOLATED BATTERY DETECTION

(71) Applicant: TEXAS INSTRUMENTS INCORPORATED, Dallas, TX (US)

(72) Inventors: Alvaro AGUILAR, Irving, TX (US); Jeffrey FALIN, Dallas, TX (US)

(21) Appl. No.: 18/591,927

(22) Filed: Feb. 29, 2024

(51) Int. Cl. H02J 7/00

(52) U.S. Cl. CPC H02J 7/0036; H02J 7/0013; H02J 7/0047

(57) ABSTRACT

In some examples, a circuit includes an amplifier and a comparator. The amplifier has an output terminal, first and second input terminals, and an enable terminal, the second input terminal of the amplifier coupled to the output terminal of the amplifier. The comparator has an output terminal and first and second input terminals, the first input terminal of the comparator coupled to the first input terminal of the amplifier, and the output terminal of the comparator coupled to the enable terminal of the amplifier.

### BACKGROUND

Various electronic devices include a battery for powering the device untethered from a wired power adapter or power source. However, the electronic devices may also be powered by the wired power adapter concurrently, or in the absence of the battery.

### SUMMARY

In some examples, a circuit includes an amplifier and a comparator. The amplifier has an output terminal, first and second input terminals, and an enable terminal, the second input terminal of the amplifier coupled to the output terminal of the amplifier. The comparator has an output terminal and first and second input terminals, the first input terminal of the comparator coupled to the first input terminal of the amplifier, and the output terminal of the comparator coupled to the enable terminal of the amplifier.

In some examples, a circuit includes a power converter, a battery detection circuit, and a controller. The power converter has an input terminal, an output terminal, and a control terminal, the input terminal coupled to an input voltage terminal of the circuit, and the output terminal coupled to a system voltage terminal of the circuit. The battery detection circuit has first and second input terminals and first and second output terminals, the first input terminal of the battery detection circuit coupled to a battery voltage terminal of the circuit, and the first output terminal of the battery detection circuit coupled to a battery driver terminal of the circuit. The controller has an input terminal and first and second output terminals, the input terminal of the controller coupled to the second output terminal of the battery detection circuit, the first output terminal of the controller coupled to the second input terminal of the battery detection circuit, and the second output terminal of the controller coupled to the control terminal of the power converter.

In some examples, a system includes a battery charger circuit and a switch. The battery charger circuit includes a power converter, a battery detection circuit, and a controller. The power converter has an input terminal, an output terminal, and a control terminal, the input terminal coupled to an input voltage terminal of the battery charger circuit and the output terminal coupled to a system voltage terminal of the battery charger circuit. The battery detection circuit has first and second input terminals and first and second output terminals, the first input terminal of the battery detection circuit coupled to a battery voltage terminal of the battery charger circuit, and the first output terminal of the battery detection circuit coupled to a battery driver terminal of the battery charger circuit. The controller has an input terminal and first and second output terminal, the input terminal of the controller coupled to the second output terminal of the battery detection circuit, the output terminal of the controller coupled to the second input terminal of the battery detection circuit, and the second output terminal of the controller coupled to the control terminal of the power converter. The switch has a control terminal and having first and second terminals, the control terminal of the switch coupled to the battery driver terminal, the first terminal of the switch coupled to the system voltage terminal, and the second terminal of the switch coupled to the battery voltage terminal.

### BRIEF DESCRIPTION OF THE DRAWINGS

FIG. 1 is a block diagram of a system, in accordance with various examples.

FIG. 2 is a block diagram of a battery charger circuit, in accordance with various examples.

FIG. 3 is a block diagram of a battery detection circuit, in accordance with various examples.

FIG. 4 is a diagram of signal waveforms, in accordance with various examples.

FIG. 5 is a flow diagram of a method, in accordance with various examples.

### DETAILED DESCRIPTION

As described above, various electronic devices include a battery for powering the device untethered from a wired power adapter or power source. In the absence of the battery, the electronic devices may continue operation, powered by the wired power adapter. Similarly, both the wired power adapter and the battery may be coupled to the electronic devices at a same time, with components of the electronic devices receiving power from the wired power adapter, the battery, or a combination of both. It may therefore be useful to determine whether the battery is or is not coupled to the electronic device at a particular point in time, for example, to maintain a stable and regulated system voltage based on power received from the wired power adapted. Various approaches may exist for performing such a detection. However, these approaches may face various challenges. For example, some approaches may modify the system voltage to determine whether the battery is coupled to the electronic device, thereby destabilizing the system voltage for other components of the electronic device. In other examples, a detection of whether the battery is coupled to the electronic device may rely on the implementation of additional pins on a integrated circuit die and/or package, or the implementation of optional external components coupled to the integrated circuit. These approaches may increase a size, and thereby cost, of the integrated circuit, rendering the integrated circuit unsuitable for certain application environments.

Examples of this disclosure provide for isolated battery detection. In some examples, the battery detection may be performed within an integrated circuit without the addition of other components external to the integrated circuit beyond those implemented in the absence of the isolated battery detection. The isolated battery detection may be performed in a manner that does not perturb the system voltage (e.g., a voltage being provided by the integrated circuit to other components of the electronic device). In some examples, the isolated battery detection is performed by modulating a voltage provided by the integrated circuit to a battery terminal based on a reference signal, where the modulation does not alter the system voltage. In some examples, the reference signal is a time-varied signal, such as signal having a periodic sinusoidal waveform, triangular waveform, trapezoidal waveform, square waveform, or any other suitable waveform shape. Responsive to detecting a change in voltage at the battery terminal less than or approximately equal to the reference signal (e.g., the voltage at the battery terminal is changing approximately proportionally to the reference signal), the integrated circuit determines that the battery is not present. Responsive to detecting a change in voltage at the battery terminal greater than the reference signal, the integrated circuit determines that the battery is present.

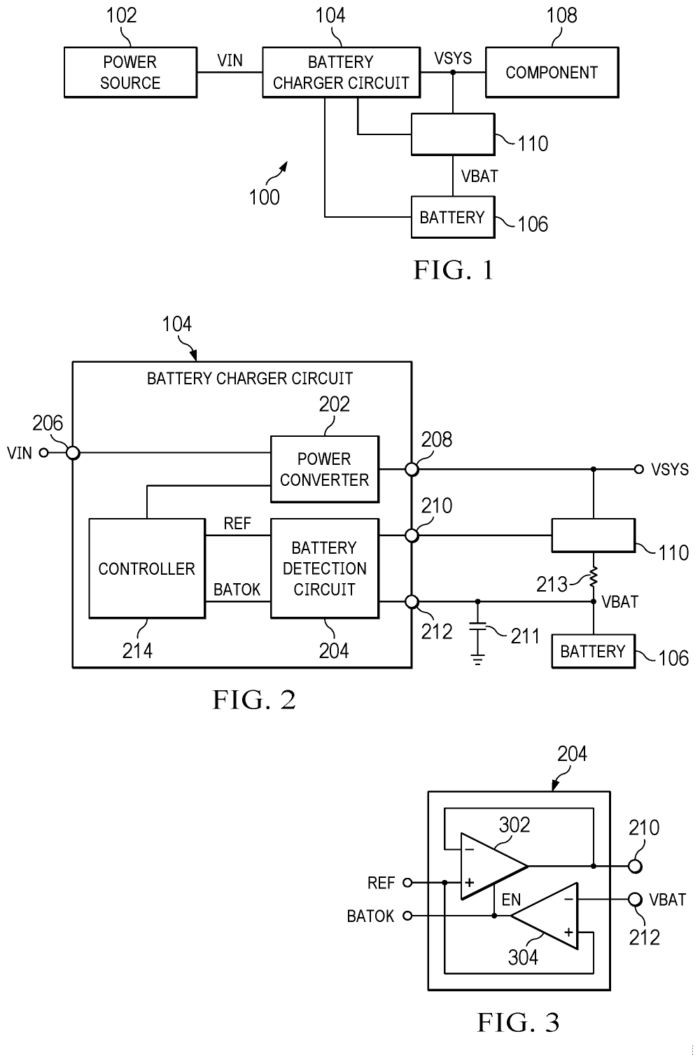

FIG. 1 is a block diagram of a system 100, in accordance with various examples. The system 100 may be generally representative of any device which receives a direct current (DC) input voltage (VIN), provides a DC system voltage (VSYS), and couples to a battery at which a battery voltage (VBAT) is provided. In an example, the system 100 includes a power source 102, a battery charger circuit 104, a battery 106, and a component 108. The power source 102 may be any power source capable of providing VIN as a DC signal, such as an alternating current (AC) to DC adapter or converter, a solar or other renewable power source, a battery, a capacitor, or the like. In some examples, the power source 102 is included in a same device (e.g., in a same housing) as a remainder of the system 100, while in other examples the power source 102 is external to a remainder of the components of the system 100. The battery charger circuit 104 may include circuitry suitable for receiving VIN, providing VSYS having a value greater than, less than, or approximately equal to VIN, controlling charging of the battery 106, and performing isolated battery detection, as described herein. The battery 106 may be any detachable or removable battery of any suitable chemistry or architecture, the scope of which is not limited herein, such that the battery 106 may be deemed “replaceable” or “user-replaceable.” In some examples, the battery 106 may be implemented as a battery module or other device that includes additional components or circuitry beyond simply a power storage structure. In some examples, the battery 106 may be a capacitor, such as a super-capacitor, or another form of energy storage device known by a term other than “battery” but which charges, stores, and discharges energy. The component 108 may be any component which receives VSYS and operates based on VSYS. For example, the component 108 may be a sensor, a camera, a speaker, a display, a microphone, a DC motor, a processing circuit such as a processor, microprocessor, controller, microcontroller, or the like. In some examples, the component 108 may be functional for a particular range (e.g., safe operating range) of values of VSYS, where VSYS having a value outside of that safe operating range may cause the component 108 to cease expected functionality, such as resetting, restarting, shutting down, or operating in an unknown, and potentially uncontrolled, state.

In an example, the battery charger circuit 104 performs isolated battery detection. For example, the battery 106 may be coupled by a switch 110 to a node at which VSYS is provided. The switch 110 may be controlled by the battery charger circuit 104. While shown in FIG. 1 as being separate from the battery charger circuit 104, in some examples the switch 110 may be a component of, and included with a package or housing of, the battery charger circuit 104. In some examples, the switch 110 is a transistor, such as a n-channel metal oxide semiconductor field effect transistor (NMOS). In other examples, the switch 110 is a bi-polar junction transistor. In yet other examples, the switch 110 is a mechanical or electromechanical relay. Generally, the switch 110 may be any controllable device, controllable by the battery charger circuit 104 to electrically couple, or decouple, the battery 106 from the node at which the battery charger circuit 104 provides VSYS.

The battery charger circuit 104 may generate, or receive, a reference signal (REF) (as shown in FIG. 2). The reference signal may be time-varied, such as a periodic signal of any suitable waveform shape. In some examples, the battery charger circuit 104 generates the reference signal internally, such as via components included in the package of the battery charger circuit 104. In other examples, the battery charger circuit 104 receives the reference signal from any suitable source, the scope of which is not limited herein. Based on the reference signal, the battery charger circuit 104 modulates the providing of VSYS to the battery 106. For example, the battery charger circuit 104 may control conductivity of the switch 110 based on the reference signal. In an example of the system 100 in which the switch 110 is a NMOS, the reference signal may cause the switch 110 to operate in a low-dropout (LDO) mode in which electrical characteristics of the switch 110 approximate a resistor coupled between the node at which VSYS is provided at the battery 106. Thus, by controlling the conductivity of the switch 110, the battery charger circuit 104 controls an effective series resistance of the switch 110. By controlling the effective series resistance of the switch 110, the battery charger circuit 104 modulates a voltage provided to the battery 106 to have a waveform shape and value approximately equal to the reference signal.

The battery charger circuit 104 includes a terminal (e.g., pin, node, etc.) at which the battery 106 couples. This terminal may have a parasitic capacitance that is inherent to the terminal and occurs irrespective of whether a discrete capacitive component is coupled to the terminal. The parasitic capacitance may, however be comparatively small in value. In other examples, a discrete component (not shown) having a non-zero amount of capacitance may be coupled to the terminal of the battery charger circuit 104 at which the battery 106 couples. The capacitance presented at the terminal of the battery charger circuit 104 at which the battery 106 couples, in the absence of the battery 106, may be referred to herein as a parasitic capacitance irrespective of whether the capacitance results from including a discrete component coupled to the terminal, the capacitance being inherently occurring, or a combination of both. In some examples, the parasitic capacitance has a value in a range of approximately 1 microfarad (uF) to approximately 100 uF. In some examples, the parasitic capacitance has a value of approximately 10 uF. As a result, in the absence of the battery 106 (e.g., responsive to the battery 106 being decoupled from the battery charger circuit 104), a voltage provided at the terminal may change approximately proportionally to the reference signal and responsive to a change in value of the reference signal. Thus, in the absence of the battery 106, the voltage provided at the terminal may approximately equal the reference signal. However, in the presence of the battery 106, the voltage provided at the terminal may not change approximately proportionally to the reference signal. For example, the battery 106 may present at the terminal as a large capacitor, which may therefore take an increased amount of time to change in value in comparison to the parasitic capacitance.

Because of the difference in behavior of the voltage provided at the terminal in the absence, or presence, of the battery 106, the voltage provided at the terminal may be used to determine whether the battery 106 is present. For example, the battery charger circuit 104 may compare the reference signal to the voltage provided at the terminal. Responsive to the reference signal being greater than, or equal to, the voltage provided at the terminal, the battery charger circuit 104 May determine that the battery 106 is decoupled from the battery charger circuit 104. Conversely, responsive to the reference signal being less than the voltage provided at the terminal, the battery charger circuit 104 may determine that the battery 106 is coupled to the battery charger circuit 104. However, irrespective of whether the battery 106 is or is not coupled to the battery charger circuit 104, VSYS may be unperturbed by the battery detection operations. Thus, battery detection of the battery 106 by the battery charger circuit 104 may be isolated from VSYS and the component 108.

FIG. 2 is a block diagram of the battery charger circuit 104, in accordance with various examples. Although the battery charger circuit 104 of FIG. 2 is described in the context of the system 100 of FIG. 1, in various examples the battery charger circuit 104 may be suitable for implementation in other system, components, devices, or the like. In an example, the battery charger circuit 104 includes a power converter 202 and a battery detection circuit 204. In some examples, the power converter 202 is a buck power converter, a boost power converter, a buck-boost power converter, a low-dropout regulator, a switch mode power converter, or any other circuit or component(s) suitable for receiving VIN and providing VSYS based on VIN. In an example, the battery detection circuit 204 includes a VIN terminal 206, a VSYS terminal 208, a battery driver terminal 210, and a VBAT terminal 212.

The power converter 202 may have an input coupled to the VIN terminal 206 and an output coupled to the VSYS terminal 208. In some examples, the power converter 202 also couples via other terminals (not shown) to other components (not shown) which may be external to the battery charger circuit 104, such as an inductor. The battery detection circuit 204 has an input coupled to the VBAT terminal 212 and an output coupled to the battery driver terminal 210. In some examples, the switch 110 has a control terminal (e.g., a gate in an example of a MOSFET) coupled to the battery driver terminal 210, a first terminal (e.g., a drain in an example of a MOSFET) coupled to the VSYS terminal 208, and a second terminal (e.g., a source in an example of a MOSFET) coupled to the VBAT terminal 212. In some examples, a capacitor 211 is coupled between the VBAT terminal 212 and a ground node at which a ground voltage potential is provided. The capacitor may have a capacitance of about 10 uF, as described above. In some examples, the capacitor 211 is included in the battery charger circuit 104, while in other examples the capacitor 211 is external to the battery charger circuit 104. In some examples, a resistor 213 is coupled between second terminal of the switch 110 and the VBAT terminal 212. The resistor 213 may a sense resistor, such as enabling detection of an amount of current flowing through the switch 110. The resistor 213 may also limit an amount of current flowing through the switch 110 into the battery 106 in examples in which the battery 106 is present.

In some examples, the power converter 202 and the battery detection circuit 204 are controlled by a controller 214. The controller 214 may be included in the battery charger circuit 104, as shown in FIG. 2, or may be external to and coupled to the battery charger circuit 104. The controller 214 may control the power converter 202 by providing control signals to control conductivity of switching components (not shown), such as transistors, of the power converter 202. Generally, the controller 214 may control the power converter 202 and the power converter 202 may operate to provide VSYS based to VIN according to any suitable process(es), the scope of which is not limited herein.

The controller 214 may control the battery detection circuit 204 by providing a reference signal for controlling the switch 110, and may receive a battery detection signal (BATOK) from the battery detection circuit 204. In some examples, the controller 214 provides the reference signal to the battery detection circuit 204 directly. In other examples, the controller 214 controls a reference circuit (not shown) to provide the reference signal to the battery detection circuit 204. The battery detection circuit 204 of FIG. 2 may operate in a manner suitable for performing the isolated battery detection described above with respect to the battery charger circuit 104 of FIG. 1, and such description is not repeated herein with respect to FIG. 2.

FIG. 3 is a block diagram of the battery detection circuit 204, in accordance with various examples. Although the battery detection circuit 204 of FIG. 3 is described in the context of the system 100 of FIG. 1 and battery charger circuit 104 of FIG. 2, in various examples the battery detection circuit 204 may be suitable for implementation in other system, components, devices, or the like. For example, the battery detection circuit 204 may be implemented to detect a plugin event of a conductor or connector having a capacitance substantially larger than a parasitic capacitance provided at a terminal or which the battery detection circuit 204 and the connector couple. In some examples, the battery detection circuit 204 as shown in FIG. 3 may be implemented in a separate electrical component package or housing than a remainder of the battery charger circuit 104 and may couple to the battery charger circuit 104.

In an example, the battery detection circuit 204 includes an amplifier 302 and a comparator 304. In some examples, the amplifier 302 may be a gated amplifier, such that the amplifier 302 provides an output signal responsive to receipt of an asserted enable signal, and blocks or does not provide the output signal responsive to receive of the enable signal having a deasserted value (or, more generally, in the absence of the asserted enable signal). As used herein, the enable signal may be asserted when the enable signal has a logic-level high (e.g., digital logic “1”) value.

The amplifier 302 has a first input terminal (e.g., a positive or non-inverting input terminal) configured to receive the reference signal. For example, the amplifier 302 may couple to the controller 214 via the first input terminal of the amplifier 302. The amplifier 302 also has a second input terminal (e.g., a negative or inverting input terminal) and an output terminal. The output terminal of the amplifier 302 is coupled to the second input terminal of the amplifier 302. The output terminal of the amplifier 302 may also couple to the battery driver terminal 210. The comparator 304 has a first input terminal (e.g., a positive or non-inverting input terminal) coupled to the first input terminal of the amplifier 302 (e.g., to receive the reference signal), a second input terminal coupled to the VBAT terminal 212, and an output terminal. In an example, the comparator 304 provides BATOK at the output terminal of the comparator 304. In some examples, the output terminal of the comparator 304 is coupled to an enable terminal of the amplifier 302 such that BATOK is the enable signal for the amplifier 302. In some examples, the output terminal of the comparator 304 is coupled to the controller 214, such as to provide BATOK to the comparator 304. In some examples, BATOK may be an active-low signal. For example, BATOK having a logic-level high (e.g., digital logic “1”) value may indicate that the battery 106 is not coupled to the battery charger circuit 104, and BATOK having a logic-level low (e.g., digital logic “0”) value may indicate that the battery 106 is coupled to the battery charger circuit 104. The battery detection circuit 204 of FIG. 3 may operate in a manner suitable for performing the isolated battery detection described above with respect to the battery charger circuit 104 of FIG. 1 and battery detection circuit 204 of FIG. 2, and such description is not repeated herein with respect to FIG. 3.

In some examples, battery detection operations of the battery detection circuit 204 may be performed under control of the controller 214. For example, the controller 214 may implement a digital state machine, or other executable, programmable, or logic function, to determine a value for REF. In an example, responsive to BATOK transitioning from a logic-level high value to a logic-level low value, the controller 214 may cause REF to transition to having a value of approximately 0 V. In this way, battery detection operations of the battery detection circuit 204 may be disabled by the controller 214. The controller 214 may subsequently resume providing VREF having a modulated value, as described above herein, such as responsive to receipt of another signal by the controller 214, the scope of which is not limited herein. In some examples, the signal may indicate that the capacitor 211 has been charged and/or discharged greater than a threshold number of times within a threshold amount of time. For example, responsive to the controller 214 determining that the capacitor 211 has been charged and/or discharged greater than the threshold number of times within the threshold amount of time, the controller 214 may determine that the battery 106 is not present. Responsive thereto, the controller 214 may re-enable the battery detection operations of the battery detection circuit 204.

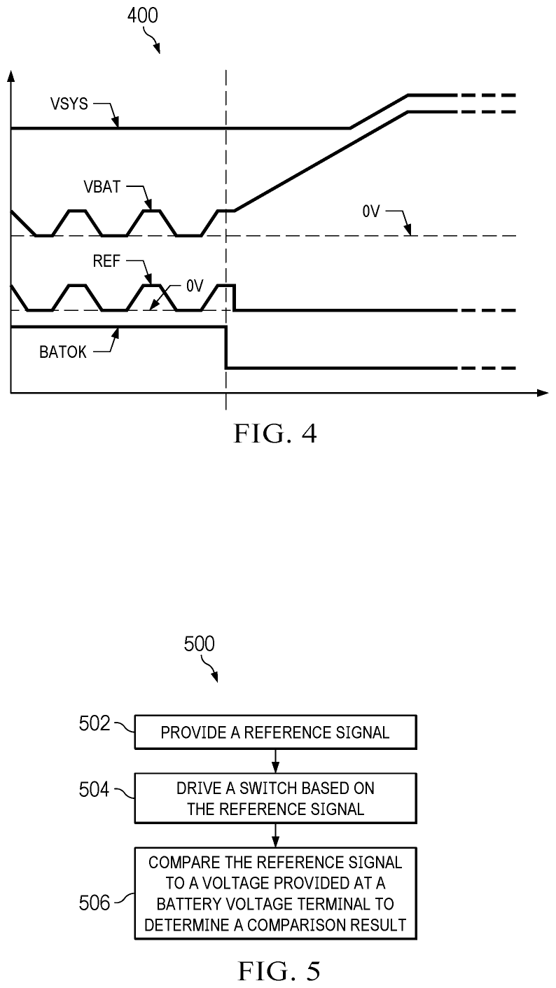

FIG. 4 is a diagram 400 of signal waveforms, in accordance with various examples. In an example, the diagram 400 shows ideal waveforms such that timing variations and transient responses that may occur in one or more signals represented in the diagram 400 are not present in the waveforms shown in FIG. 4. The diagram 400 includes VSYS, VBAT, REF, and BATOK.

As described above and shown by the diagram 400, responsive to the battery 106 being decoupled from the battery charger circuit 104, VBAT has a value approximately equal to REF and BATOK has a logic-level high value. As REF changes in value under modulation by the battery detection circuit 204, VBAT changes proportionally and responsively thereto in the absence of the battery 106. Responsive to battery 106 being coupled to the battery charger circuit 104, VBAT has a value greater than REF and BATOK transitions to a logic-level low value. The battery charger circuit 104 may subsequently begin charging the battery 106, further increasing the value of VBAT with respect to REF. Although not shown in FIG. 4, responsive to a subsequent decoupling of the battery 106 from the battery charger circuit 104, VBAT may decrease in value to become less than REF, and BATOK may transitions to again have a logic-level high value.

FIG. 5 is a flow diagram of a method 500, in accordance with various examples. In some examples, the method 500 is implemented in a system, such as the system 100, to determine the presence or absence of a battery, such as the battery 106. The method 500 may be implemented in whole or in part by a battery charger circuit, such as the battery charger circuit 104. For example, the method 500 may be implemented in whole or in part by a battery detection circuit, such as the battery detection circuit 204, of, or coupled to, the battery charger circuit.

At operation 502, a reference signal is provided. In some examples, the reference signal is a time-varied signal, such as signal having a periodic sinusoidal waveform, triangular waveform, trapezoidal waveform, square waveform, or any other suitable waveform shape.

At operation 504, a switch is driven based on the reference signal. In some examples, the switch is driven by the reference signal to modulate a voltage provided at a battery voltage terminal. The switch may be, for example, a MOSFET transistor operated in an LDO mode to approximate electrical characteristics of a resistor.

At operation 506, the reference signal is compared to the voltage provided at the battery voltage terminal to determine a comparison result. In examples in which the battery is not present, the reference signal may have a value greater than or equal to the voltage provided at the battery voltage terminal. In such an example, the comparison result may have a logic-level high value. In examples in which the battery is present, the reference signal may have a value less than the voltage provided at the battery voltage terminal. In such an example, the comparison result may have a logic-level low value.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

What is claimed is:

1. A circuit, comprising:
an amplifier having an output terminal, first and second input terminals, and an enable terminal, the second input terminal of the amplifier coupled to the output terminal of the amplifier; and
a comparator having an output terminal and first and second input terminals, the first input terminal of the comparator coupled to the first input terminal of the amplifier, and the output terminal of the comparator coupled to the enable terminal of the amplifier.

2. The circuit of claim 1, wherein the second input terminal of the comparator is coupled to a battery voltage terminal of a battery charger circuit.

3. The circuit of claim 1, wherein the output terminal of the amplifier is coupled to a battery driver terminal of a battery charger circuit.

4. The circuit of claim 1, wherein the output terminal of the comparator is coupled to a controller.

5. The circuit of claim 4, wherein the controller is configured to provide a reference signal at the first input terminal of the amplifier.

6. The circuit of claim 1, wherein the amplifier is configured to receive a reference signal at the first input terminal of the amplifier.

7. The circuit of claim 6, wherein the reference signal is a time-varied signal.

8. The circuit of claim 6, wherein the amplifier is configured to provide a signal at the output terminal of the amplifier configured to modulate a voltage provided at the second input terminal of the comparator.

9. A circuit, comprising:
a power converter having an input terminal, an output terminal, and a control terminal, the input terminal coupled to an input voltage terminal of the circuit, and the output terminal coupled to a system voltage terminal of the circuit;
a battery detection circuit having first and second input terminals and first and second output terminals, the first input terminal of the battery detection circuit coupled to a battery voltage terminal of the circuit, and the first output terminal of the battery detection circuit coupled to a battery driver terminal of the circuit; and
a controller having an input terminal and first and second output terminals, the input terminal of the controller coupled to the second output terminal of the battery detection circuit, the first output terminal of the controller coupled to the second input terminal of the battery detection circuit, and the second output terminal of the controller coupled to the control terminal of the power converter.

10. The circuit of claim 9, wherein the battery detection circuit comprises:
an amplifier having an output terminal, first and second input terminals, and an enable terminal, the output terminal of the amplifier coupled to the battery driver terminal and to the second input terminal of the amplifier, and the first input terminal of the amplifier coupled to the first output terminal of the controller; and
a comparator having an output terminal and first and second input terminals, the first input terminal of the comparator coupled to the first input terminal of the amplifier, and the output terminal of the comparator coupled to the enable terminal of the amplifier and to the input terminal of the controller.

11. The circuit of claim 10, wherein the power converter is configured to provide a system voltage signal at the system voltage terminal responsive to receipt of an input voltage provided at the input voltage terminal.

12. The circuit of claim 11, wherein the battery detection circuit is configured to modulate a voltage provided at the battery driver terminal of the circuit based on a reference signal received at the first input terminal of the amplifier to induce a change in voltage at the battery voltage terminal.

13. The circuit of claim 12, wherein the battery detection circuit is configured to compare the reference signal to a voltage provided at the battery voltage terminal to determine a comparison result indicating presence or absence of a battery coupled to the battery voltage terminal, wherein the comparison result indicating that the reference signal has a value less than the voltage provided at the battery voltage terminal indicates that the battery is coupled to the battery voltage terminal.

14. A system, comprising:
a battery charger circuit, comprising:
a power converter having an input terminal, an output terminal, and a control terminal, the input terminal coupled to an input voltage terminal of the battery charger circuit and the output terminal coupled to a system voltage terminal of the battery charger circuit;
a battery detection circuit having first and second input terminals and first and second output terminals, the first input terminal of the battery detection circuit coupled to a battery voltage terminal of the battery charger circuit, and the first output terminal of the battery detection circuit coupled to a battery driver terminal of the battery charger circuit; and
a controller having an input terminal and first and second output terminal, the input terminal of the controller coupled to the second output terminal of the battery detection circuit, the output terminal of the controller coupled to the second input terminal of the battery detection circuit, and the second output terminal of the controller coupled to the control terminal of the power converter; and
a switch having a control terminal and having first and second terminals, the control terminal of the switch coupled to the battery driver terminal, the first terminal of the switch coupled to the system voltage terminal, and the second terminal of the switch coupled to the battery voltage terminal.

15. The system of claim 14, wherein the battery detection circuit comprises:
an amplifier having an output terminal, first and second input terminals, and an enable terminal, the output terminal of the amplifier coupled to the control terminal of the switch and to the second input terminal of the amplifier, and the first input terminal of the amplifier coupled to the first output terminal of the controller; and
a comparator having an output terminal and first and second input terminals, the first input terminal of the comparator coupled to the first input terminal of the amplifier, the output terminal of the comparator coupled to the enable terminal of the amplifier and to the input terminal of the controller, and the second input terminal of the comparator coupled to the battery voltage terminal.

16. The system of claim 15, wherein the battery detection circuit is configured to:
receive a reference signal; and
modulate a signal provided at the control terminal of the switch to control an equivalent series resistance of the switch, wherein modulating the signal provided at the control terminal of the switch causes a signal having a same waveform shape as the reference signal to be provided at the second terminal of the switch.

17. The system of claim 16, wherein the reference signal is a time-varied signal.

18. The system of claim 16, wherein the battery detection circuit is configured to:
detect a battery voltage signal at the second input terminal of the comparator; and
compare the reference signal to the battery voltage signal to determine a comparison result, wherein the comparison result has a logic-level low value responsive to the battery voltage signal being greater in value than the reference signal.

19. The system of claim 18, wherein the battery detection circuit is configured to determine that a battery is coupled to the battery voltage terminal responsive to the comparison result having the logic-level low value.

20. The system of claim 16. wherein the battery detection circuit is configured to control the switch to provide the signal having the same waveform shape as the reference signal at the second terminal of the switch without affecting a voltage value of a system voltage provided at the system voltage terminal.
